(19) United States
(12) Patent Application Publication
(10) Pub. No.: US 2018/0108089 A1
(43) Pub. Date: Apr. 19, 2018

(54) TRANSACTIONS AND LINKED ASSETS ON A BLOCKCHAIN

(71) Applicant: International Business Machines Corporation, Armonk, NY (US)

(72) Inventor: Praveen Jayachandran, BANGALORE (IN)

(21) Appl. No.: 15/294,272

(22) Filed: Oct. 14, 2016

(51) Int. Cl. G06Q 40/06; G06Q 30/02

(52) U.S. Cl. CPC G06Q 40/06; G06Q 30/0282

(57) ABSTRACT

A blockchain configuration may log asset data as well as transaction data. One example method of operation may include logging a transaction on a blockchain, linking assets to the transaction, recording a current asset state on the blockchain of the assets responsive to linking the assets to the transaction, determining parties to the blockchain transaction have requirement criteria associated with the current asset state, and monitoring the current asset state to identify whether a lapse in the requirement criteria has occurred.

### TECHNICAL FIELD

This application relates to identifying asset states, linking assets to blockchain transactions and tracking assets in the blockchain, and more particularly to keeping a record of asset changes and related information in the blockchain for reference and planning of transactions.

### BACKGROUND

Transactions can occur utilizing a blockchain which can maintain a log of transactions. The transactions on the blockchain are usually related to a purchase or sale of goods or assets. The assets are therefore part of the blockchain transaction even though the transactions may not specify the asset data. As such, there is a need for entities or individuals, such as buyers, sellers, producers, consumers, etc., to have preferences with regard to assets which are bought or sold.

### SUMMARY

One example embodiment may include a method that includes at least one of logging a transaction on a blockchain, linking assets to the transaction, recording a current asset state on the blockchain of the one or more assets responsive to linking the assets to the transaction, determining one or more parties to the blockchain transaction has a requirement criteria associated with the current asset state, and monitoring the current asset state to identify whether a lapse in the requirement criteria has occurred.

Another example embodiment may include an apparatus that includes a processor configured to log a transaction on a blockchain, link one or more assets to the transaction, record a current asset state on the blockchain of the one or more assets responsive to the one or more assets being linked to the transaction, determine one or more parties to the blockchain transaction has a requirement criteria associated with the current asset state, and monitor the current asset state to identify whether a lapse in the requirement criteria has occurred.

Another example embodiment may include a non-transitory computer readable storage medium configured to store instructions that when executed causes a processor to perform at least one of logging a transaction on a blockchain, linking one or more assets to the transaction, recording a current asset state on the blockchain of the one or more assets responsive to linking the one or more assets to the transaction, determining one or more parties to the blockchain transaction has a requirement criteria associated with the current asset state, and monitoring the current asset state to identify whether a lapse in the requirement criteria has occurred.

### BRIEF DESCRIPTION OF THE DRAWINGS

FIG. 1 illustrates a block diagram of a blockchain network configuration according to example embodiments.

FIG. 2 illustrates a system signaling diagram of a blockchain transaction and asset management configuration according to example embodiments.

FIG. 3 illustrates a flow diagram of an example method of operation according to example embodiments.

FIG. 4 illustrates an example network entity configured to support one or more of the example embodiments.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, and system, as represented in the attached figures, is not intended to limit the scope of the application as claimed, but is merely representative of selected embodiments.

The instant features, structures, or characteristics as described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” may have been used in the description of embodiments, the application may be applied to many types of network data, such as, packet, frame, datagram, etc. The term “message” also includes packet, frame, datagram, and any equivalents thereof. Furthermore, while certain types of messages and signaling may be depicted in exemplary embodiments they are not limited to a certain type of message, and the application is not limited to a certain type of signaling.

Example embodiments provide an application and/or software procedure which identifies an existing blockchain configuration and includes asset information with transaction information. A supplier may enter a blockchain transaction by selling a product, receiving a product, or agreeing to any exchange of goods or services associated with a blockchain transaction. Blockchain is generally used to maintain information on financial transactions, such as sales and purchases, however, there exists additional information which can be included in the blockchain. For example, the products or assets which are related to the blockchain transactions can be identified by logistical information, such as creation date, certifications (e.g., organic, natural, lead-free, fair wage employment, etc.), expiration date, product information, etc. In one example, a supplier may be interested in information regarding raw materials which were purchased to make other products. The raw materials can be linked to the blockchain by an identifier and then the ultimate product can be linked back to the raw materials used to make the product. The final products can be the assets linked to the blockchain and provided to or accessed by the consumers operating on the blockchain. Other entities and information, such as transport services, containers, truck/ship rental purchases, etc. can be assets which are linked to the blockchain for the product manufacturers, producers, etc., operating on the blockchain.

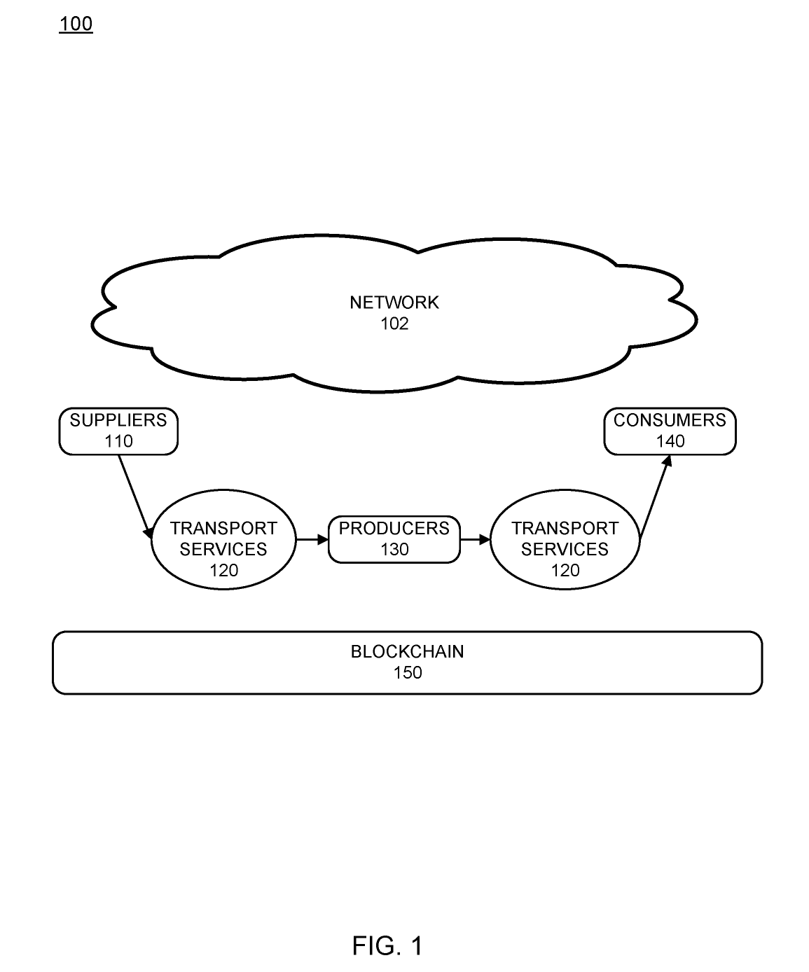

FIG. 1 illustrates a block diagram of a blockchain network configuration according to example embodiments. Referring to FIG. 1, the network 100 includes a cloud or other type of communication network 102 which hosts the communication for the blockchain infrastructure 150. The transactions conducted over the blockchain 150 include those performed by suppliers 110, transport services 120 and producers 130. Each of the parties to the blockchain transactions (which are performed via one or more devices including a processor and memory—not shown) may have access to product and/or service information, such as asset state information, linkage information from one product to the next to identify a chain of custody of products and services, etc. The suppliers 110 are generally the parties with the earliest blockchain transaction data, such as raw material purchases, shipping purchases for products purchased, etc. The consumers 140 generally create the later and more recent transaction data by purchasing the products which were created and shipped by the suppliers. Transport services 120 and producers 130 are part of the entire sequence of blockchain transactions which may have common associations with the blockchain on a periodic basis since those types of services are used in many different types of transactions.

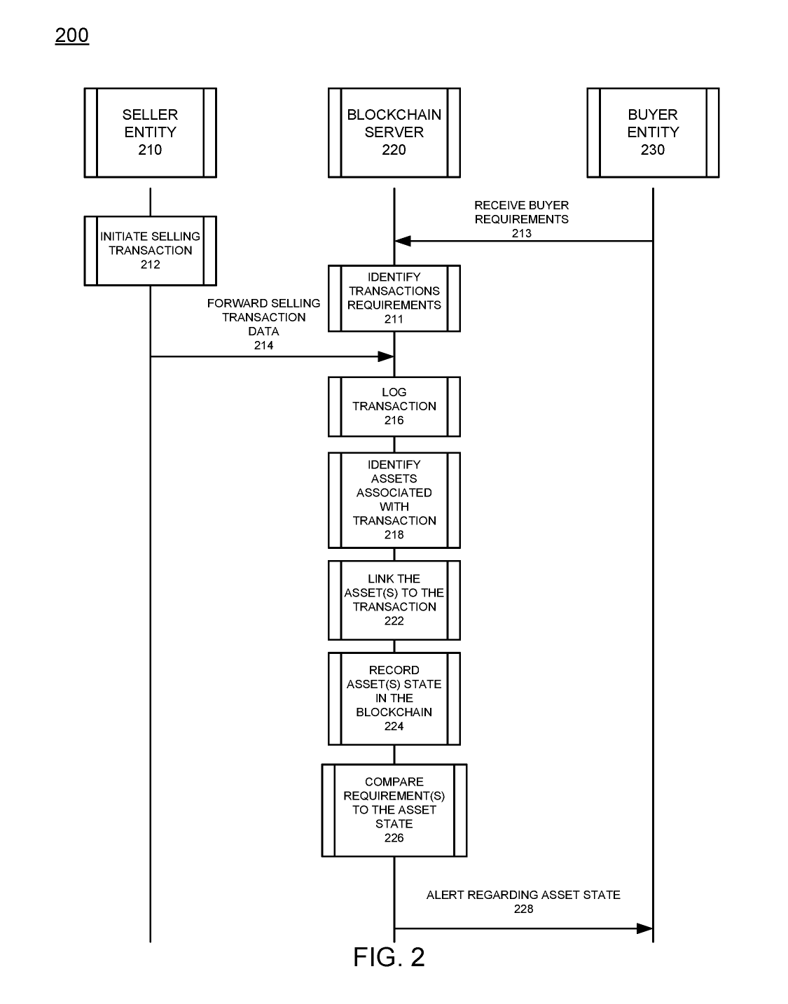

FIG. 2 illustrates a system signaling diagram of a blockchain transaction and asset management configuration according to example embodiments. Referring to FIG. 2, the system configuration 200 includes at least one seller entity 210 and one buyer entity 230. Those entities communicate through a blockchain server 220 which may be a server hosting, processing, and/or storing the blockchain data. During one or more blockchain transactions, the buyer and seller entities may be known to the blockchain server 220 based on various data, such as a product for purchase, a price and other common blockchain data 211. Buyer requirements 213 may be received which indicate the types of asset information which are required, or which may be desired to be known during the blockchain communications and/or when changes occur.

In operation, a selling transaction may be initiated 212, which may include forwarding selling transaction data 214 to the blockchain server 220. The transaction data may be logged 216 as part of the blockchain along with the requirements, asset data 218, etc. A linking operation may be performed to link the assets to the blockchain transactions 222. As a result, a current asset state may be recorded 224 on the blockchain to represent the one or more assets. This may be performed responsive to linking the assets to the transaction. At some point in the transaction process, one or more parties to the blockchain transaction or asset may have a specific requirement criteria that must be acknowledged with regard to the current asset state 226. The current asset state may be monitored to identify whether a lapse in the requirement criteria has occurred 228.

The asset state may include a date, quality level, certification, organic label, perishable label, etc. The asset state may also be a part that is being manufactured and could be currently logged as being in particular state, such as ‘created’, ‘machine X worked on it’, ‘machine Y polished it’, ‘packed’, ‘shipped’, etc. The states will be stored on the blockchain. Changing the asset state will be regarded as a logged transaction on the blockchain with the state information maintained in the transaction. Similarly, assets such as a truck, transported operations, a set of parts, and for a certain duration of time, can be linked together. The truck and the parts, for example, are linked together when the parts are loaded into the truck, and they are de-linked when they are unloaded from the truck. This provides a consistent tamper-proof record of which trucks carry which parts.

A transaction may be of one of the following types: (i) an asset was created, (ii) an asset's state was changed, for instance, the state is stored as part of the transaction, (iii) two or more assets are linked together, and (iv) two or more assets that were linked earlier are now unlinked. Transactions on the blockchain may be queried/analyzed to determine the sequence of events that occurred and the most recent state of each asset. Linking and de-linking/unlinking are status changes which are maintained in the blockchain to track assets and determine other assets which have been interacting with those assets.

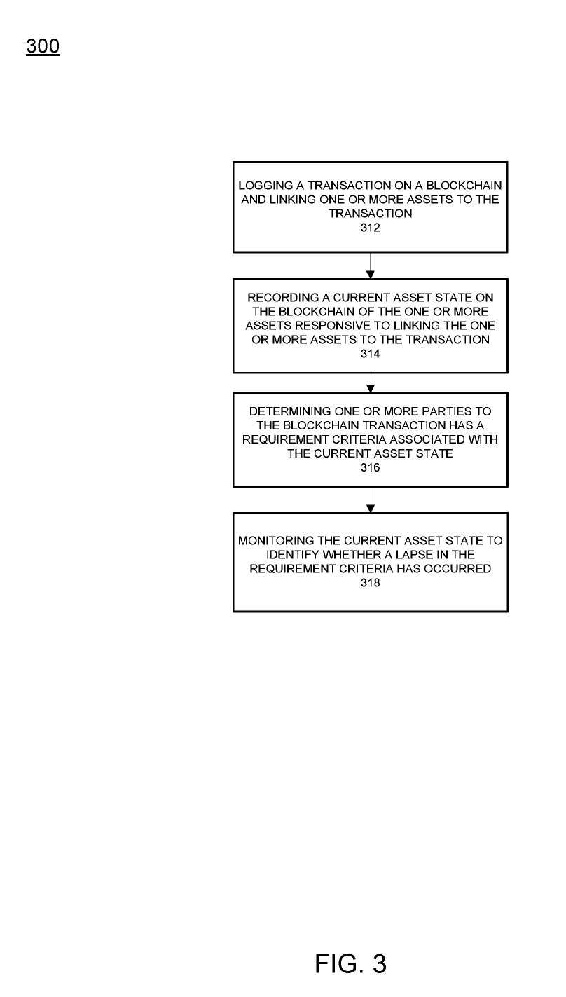

FIG. 3 illustrates a flow diagram of an example method of operation according to example embodiments. Referring to FIG. 3, the method 300 may include one or more of logging a transaction on a blockchain and linking the assets to the transaction(s) 312, recording a current asset state on the blockchain of the one or more assets responsive to linking the assets to the transaction(s) to the one or more assets 314, determining one more parties to the blockchain transaction has a requirement criteria associated with the current asset state 316 and monitoring the current asset state to identify whether a lapse in the requirement criteria has occurred 318.

The requirement criteria may include a product rating, product compliance measure, certification, etc. The current asset state may include a produced state. The current asset state can change to a consumed state responsive to a lapse in a period of time. The current asset state can also be unlinked on the blockchain responsive to receiving an indication that the one or more assets are consumed or are no longer active or have been removed. The current asset state may also perform creating an alert responsive to identifying the current asset state has lapsed in the requirement criteria, for example, if the asset has changed its status, the status could be indicative of a violation of the requirement criteria and all interested parties should be informed via a message originating from the blockchain. In addition, as more transactions occur on the blockchain, it can be determined whether any changes to the asset state have occurred and whether any changes to the requirement criteria have occurred based on the additional transactions.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

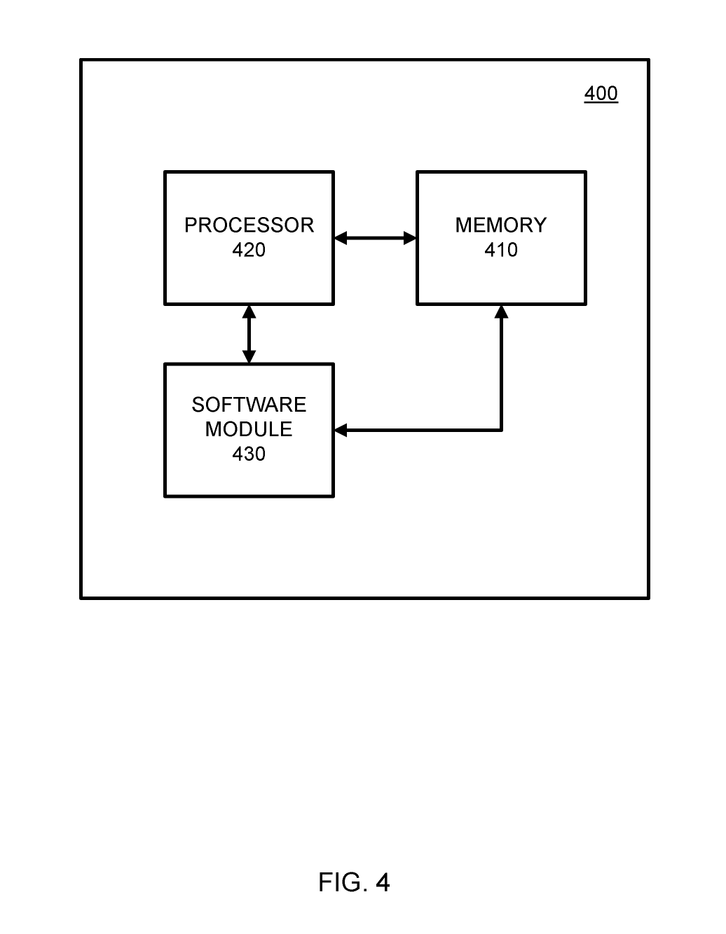

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 4 illustrates an example network element 400, which may represent or be integrated in any of the above-described components, etc.

As illustrated in FIG. 4, a memory 410 and a processor 420 may be discrete components of a network entity 400 that are used to execute an application or set of operations as described herein. The application may be coded in software in a computer language understood by the processor 420, and stored in a computer readable medium, such as, a memory 410. The computer readable medium may be a non-transitory computer readable medium that includes tangible hardware components, such as memory, that can store software. Furthermore, a software module 430 may be another discrete entity that is part of the network entity 400, and which contains software instructions that may be executed by the processor 420 to effectuate one or more of the functions described herein. In addition to the above noted components of the network entity 400, the network entity 400 may also have a transmitter and receiver pair configured to receive and transmit communication signals (not shown).

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way, but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed, but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method, comprising:
logging a transaction on a blockchain;
linking one or more assets to the transaction;
recording a current asset state on the blockchain of the one or more assets responsive to linking the one or more assets to the transaction;
determining one or more parties to the blockchain transaction has a requirement criteria associated with the current asset state; and
monitoring the current asset state to identify whether a lapse in the requirement criteria has occurred.

2. The method of claim 1, wherein the requirement criteria comprises one or more of a product rating and product compliance.

3. The method of claim 1, wherein the current asset state comprises a produced state.

4. The method of claim 1, wherein the current asset state changes to a consumed state responsive to a lapse in a period of time.

5. The method of claim 4, further comprising:
unlinking the current asset state on the blockchain responsive to receiving an indication that the one or more assets are consumed.

6. The method of claim 1, further comprising:
creating an alert responsive to identifying the current asset state has lapsed in the requirement criteria.

7. The method of claim 1, further comprising:
logging another transaction on the blockchain; and
determining whether any changes to the asset state have occurred and whether any changes to the requirement criteria have occurred based on the another transaction.

8. An apparatus, comprising:
a processor configured to:
log a transaction on a blockchain,
link one or more assets to the transaction,
record a current asset state on the blockchain of the one or more assets responsive to the one or more assets being linked to the transaction,
determine one or more parties to the blockchain transaction has a requirement criteria associated with the current asset state, and
monitor the current asset state to identify whether a lapse in the requirement criteria has occurred.

9. The apparatus of claim 8, wherein the requirement criteria comprises one or more of a product rating and product compliance.

10. The apparatus of claim 8, wherein the current asset state comprises a produced state.

11. The apparatus of claim 8, wherein the current asset state changes to a consumed state responsive to a lapse in a period of time.

12. The apparatus of claim 11, wherein the processor is further configured to unlink the current asset state on the blockchain responsive to an indication being received that the one or more assets are consumed.

13. The apparatus of claim 8, wherein the processor is further configured to create an alert responsive to the current asset state being identified as lapsed in the requirement criteria.

14. The apparatus of claim 8, wherein the processor is further configured to log another transaction on the blockchain, and determine whether any changes to the asset state have occurred and whether any changes to the requirement criteria have occurred based on the another transaction.

15. A non-transitory computer readable storage medium configured to store instructions that when executed causes a processor to perform:
logging a transaction on a blockchain;
linking one or more assets to the transaction;
recording a current asset state on the blockchain of the one or more assets responsive to linking the one or more assets to the transaction;
determining one or more parties to the blockchain transaction has a requirement criteria associated with the current asset state; and
monitoring the current asset state to identify whether a lapse in the requirement criteria has occurred.

16. The non-transitory computer readable storage medium of claim 15, wherein the requirement criteria comprises one or more of a product rating and product compliance.

17. The non-transitory computer readable storage medium of claim 5, wherein the current asset state comprises a produced state.

18. The non-transitory computer readable storage medium of claim 15, wherein the current asset state changes to a consumed state responsive to a lapse in a period of time.

19. The non-transitory computer readable storage medium of claim 18, wherein the processor is further configured to perform:
unlinking the current asset state on the blockchain responsive to receiving an indication that the one or more assets are consumed.

20. The non-transitory computer readable storage medium of claim 15, wherein the processor is further configured to perform:
creating an alert responsive to identifying the current asset state has lapsed in the requirement criteria;
logging another transaction on the blockchain; and
determining whether any changes to the asset state have occurred and whether any changes to the requirement criteria have occurred based on the another transaction.
